(19) United States
(12) Patent Application Publication
(10) Pub. No.: US 2006/0188834 A1
(43) Pub. Date: Aug. 24, 2006

(54) Method for creating features in orthodontic aligners

(76) Inventor: Jack Keith Hilliard, Lakeland, FL (US)

Correspondence Address: DORR, CARSON & BIRNEY, P.C.;ONE CHERRY CENTER, 501 SOUTH CHERRY STREET, SUITE 800, DENVER, CO, 80246, US

(21) Appl. No.: 11/061,194

(22) Filed: Feb. 18, 2005

(51) Int. Cl. A61C 3/00

(52) U.S. Cl. 433/24; 433/6

(57) ABSTRACT

A method for creating features in an orthodontic aligner employs a hot air source having a maximum flow rate of approximately 10 liters per minute to selectively heat a small local region of the aligner above the thermoforming temperature of the aligner material. The heated region of the aligner is manipulated to form the desired feature, and then allowed to cool to solidify the feature. These features can be used, for example, to directly impart therapeutic forces on teeth, or for attachment of aligner auxiliaries to the aligner.

### BACKGROUND OF THE INVENTION

1. Field of the Invention

The present invention relates generally to the field of orthodontics. More specifically, the present invention discloses a method for creating features in orthodontic aligners by localized heating with a small stream of superheated air.

2. Background of the Invention

Many advances in dentistry and in the dental specialty of orthodontics have been driven by advances in materials science. In particular, beginning in the late 1930's, the application of various types of plastic materials led to improved treatment methods and improved armamentarium. The advent of acrylic for example, before World War II in its various forms enabled new procedures in dentistry and orthodontics. The acrylic monomer/polymer combination known as methyl methacrylate monomer and powder remains a common dental material used today for the laboratory-casting of dentures and the lay-up of palate-conforming transverse appliances of all types. Dental acrylic is also used for the palatal structure of removable orthodontic/orthopedic appliances. A typical use of methyl methacrylate involves a methodology in which the powder component and the liquid component are applied alternatingly and allowed to mix directly in a plaster duplicate of the patient's teeth called the working model. This is spoken of as the “salt and pepper method” used for building up acrylic orthodontic appliances and retainers. A release agent applied to the plaster model allows the polymerized plastic mass to be removed from the model once it has cured.

Other uses of plastics include early tooth positioners introduced in the mid-1940's. Compared to traditional steel braces, the alternative approach of using positioners to move teeth began in the mid 1940's as described by Kessling, Am J Orthod. Oral Surg. 31: 297-304 (1945) and 32:285-293 (1946). Kessling's positioners were cast from vulcanized rubber, which led to silicone rubber positioners as described by Warunek et al., J. Clin. Orthod 23:694-700 (1989). Silicone rubber is another “plastic” system that led to improvements and advances in dental procedures.

Yet another example of polymer science driving advances in dentistry is the introduction of an entire class of dental adhesives based on the styrene monomer bisphenyl diglycedal methacrylate (Bis-Gma) and urethane dimethacrylate. These systems are used extensively for dental and orthodontic bonding. Even conventional amalgam (metallic) fillings have been partially replaced by tooth-colored, fluoride-releasing, light-cured composite plastic restorative materials.

Another common use of plastics for orthodontic appliances involves plastics in sheet form. Various types of sheet plastics are used in the fabrication of a new class of tooth positioners, more recently termed “aligners”. Such appliances are informally referred to as suck-down appliances. This term is used because in order to form such an appliance, heat, vacuum and air pressure are used in combination to thermoform or, vacuum-form these materials to intimately comply with, and form over plaster duplicates of a patient's teeth.

A common piece of laboratory equipment used for such a process is known as the Bio-Star machine. Bio-Star machines are small, bench-top units that essentially replicate the industrial process known as vacuum-forming as adapted to dental applications. Today, Bio-Star machines and similarly functioning machines are used to heat-form appliances in dental laboratories and in dentists, orthodontists and pedodontist's offices worldwide. Suck-down appliances are commonly used for in-the-mouth treatment in straightening teeth as well as for other dental laboratory processes.

Regardless of whether suck-down appliances are formed by a commercial laboratory or in a doctor's in-practice laboratory, such appliances serve many treatment functions. Some are formed as mouth guards to protect an athlete's teeth during sports activities. Others are used for such things as anti-bruxism devices for protecting teeth from accelerated wear caused by grinding during sleep. Other applications for suck-down appliances include bleaching trays, trays for the application of fluoride during teeth cleaning and even for an orthodontic indirect bonding process in which the brackets (braces) are positioned and bonded to a patient's teeth.

For orthodontic treatment involving the repositioning of teeth, suck-down appliances are formed in a much more sophisticated manner in order to achieve primary orthodontic treatment objectives. For example, an orthodontist may use a suck-down appliance to achieve the last few degrees of rotation, torque or tipping of the teeth to finish an orthodontic case that is taking longer than planned to finish. Instead of continuing for several more months using conventional treatment methods with the steel braces in place, the braces can be removed and the case can be finished with an aligner. Such a step is usually met with enthusiastic support from the patient. Similar uses of aligners can involve minor tooth movements needed to correct an orthodontic case that has relapsed post treatment.

For forming a suck-down appliance to achieve orthodontic correction, an impression of the patient's teeth will first be taken and a plaster model poured from the impression, which is allowed to set up. Then, in an orthodontic laboratory setting, the plaster model will be reset. Resetting is a process in which the plaster teeth are cut free from the stone model and reattached in the final corrected positions using a special adhesive wax. From such as reset model, another impression can be taken and from that another stone model is produced and from that a progressive aligner can be formed.

For aligners that are fabricated using the resetting procedure described above, each tooth-receiving cavity formed in the aligner will be slightly out of register with the actual positions of the patient's teeth. In other words, as such a positioner is seated on a patient's teeth, the out-of-alignment relationship between the teeth and their corresponding cavities of the aligner causes a positional dissonance, causing the material of the slightly out of registration aligner to be forcibly distorted when the aligner is firmly seated on the teeth. The intentional distortion of the resilient material of the aligner causes the aligner to store energy in the same sense that a metallic spring does. It is the energy stored in the aligner that supplies a constant gentle force against the teeth, urging them toward their ultimate desired positions.

Various improvements to the classic positioner have kept pace with the developments in plastics, leading to today's thin clear, tough positionally-sophisticated heat-formed aligner. Beginning in the late 1990's, orthodontists began to exploit the full potential of treatment based on these modern versions of Kessling's tooth positioners. An example of the popular use of suck-down appliances as provided directly to orthodontists through a commercial laboratory service is seen in the commercial offering known as the Invisalign® program. The Invisalign® program is based on U.S. Pat. No. 5,975,893 (Chishti et al.), and many continued US and foreign patents, including in particular U.S. Pat. No. 6,398,548 (Muhammad et al.). The Invisalign® program involves the presentation of a patient's virtually treated finished occlusion in the form of a physical pattern. In this case, rather than a plaster pattern of teeth, the occlusion is represented by a digitally-produced physical pattern. Over such digitally-produced patterns clear, hard but flexible suck-down appliances are heat-formed just as aligners are formed over plaster models. These aligners are arch or U-shaped appliances and consist of a polymeric shell with a plurality of cavities to receive the patient's teeth.

An orthodontist or dentist participating in the Invisalign® program will approve a rendering of the virtual finished occlusion, typically via the internet. The next step in the Invisalign® process involves the creation of typically 15 to 25 incremental progressive physical models that are then used to form a corresponding series of aligners using vacuum, heat and pressure. These aligners are eventually supplied to the patient, who will wear each of them sequentially for two weeks or so.

In addition to the commercially-successful Invisalign program, it should be remembered that many suck-down tooth-repositioning aligners are also formed by commercial orthodontic laboratories and by internal laboratories, maintained by clinicians. Because of the extensive use of these plastic appliances throughout the orthodontic profession, much knowledge and experience regarding their use has been gained. Methods for maximizing and focusing corrective forces have been developed allowing aligners to elicit physiological response on a tooth-by-tooth basis.

Other methods involving the sequential activation of aligners have been developed. For example, a progressive aligner may serve in the mouth “as is” for a first period of time, and then after being reactivated through additional localized thermoforming or through the addition of separate devices, it can serve in treatment for a second period of time. Alternatively, particularly difficult corrections required by specific mal-positioned teeth can be met with special activations or specific additional devices to focus corrective forces on those teeth. After the teeth have responded by moving partially toward the desired position, other more aggressive devices can be installed in the original aligner to move teeth toward a desired outcome. For example, U.S. Pat. No. 6,293,790 (Hilliard) describes a series of pliers. The tips of the beaks of these pliers have essentially male (forming) features and female features that inter-work to locally modify the shape of an aligner or to form specific-function features in an aligner. Central to the functioning of these “Thermo Pliers” is a step where, prior to their use, they are heated to a predetermined temperature that is appropriate for the inter-working beaks to heat and thermoform the aligner material. The '790 patent describes a series of highly functional features that can be formed in an aligner using this methodology as well as various treatment-related functions of such features.

Another category of devices useful for enhancing the performance of aligners as well as re-activating aligners is described by U.S. Pat. No. 6,702,575 (Hilliard). The '575 patent teaches a series of active auxiliary devices and means for attaching such to aligners where precisely-formed holes are first pierced through the material of an aligner. One type of aligner auxiliary that is then positively forced into and retained in such holes consists of devices that individually or in combination contact the teeth and serve to focus the energy stored in an aligner to maximize the mechanical advantage of such corrective forces at selected points. Such aligner auxiliaries have features that inter-fit with the holes pierced through an aligner and are thereby firmly anchored into the aligner. The aligner auxiliary makes a point contact when contacting a tooth, and in doing so, lifts a local region of the aligner material slightly away from its passive configuration. In doing so, the aligner auxiliary gathers force from the local region of the aligner and imparts that force to a pre-determined point on a tooth. In this manner, such devices can for example be used in combination to create a force couple to achieve such difficult orthodontic treatment objectives as correcting mal-rotated cuspid teeth.

Another group of auxiliaries disclosed in the '575 patent similarly anchors into aligners through precisely-sized holes. Rather than actively contact and move teeth however, this group serves as anchors for moving adjacent teeth or adjacent groups of teeth. One step in treating certain types of orthodontic malocclusions requires an aligner to be cut either partially of completely into two sections. Those two sections and the teeth they engage can be drawn closer together tractively, or pushed apart expansively as a case may require. In order to move groups of teeth in this manner, devices disclosed in the '575 patent serve as foci for such forces, and various types of force-generating elements, such as jack screws, coil springs and elastics (latex or urethane rubber bands), that generate corrective forces between the sections of the aligner. Importantly, in order for this group of devices to anchor into an aligner, the anchor point must be locally raised or outset so that a portion of the attaching device can extend through a hole in the aligner without undesirably contacting teeth. There are several conventional methods for producing such an outset land in an aligner, including the Thermo Pliers discussed above.

In order to provide a description of the present orthodontic-related invention, it is necessary to describe a specialized group of tools used in the semiconductor industry for repairing integrated circuit boards and for salvaging components from defective integrated circuit boards. It is standard practice to scrap integrated circuit boards that have a failed component. However, for salvage and re-use of expensive integrated circuits on such boards, there is a need for very fine tools that can manually but accurately solder and de-solder the tiny contacts connecting these components to a circuit board. These tools are sometimes referred to as “SMD rework” or “resoldering units.” One example of such a tool is the Hakko 851 unit marketed by Hakko Corporation of Osaka, Japan. This unit supplies superheated air at a maximum flow rate of approximately 6 liters per minute through a tiny orifice ranging from 1 to 3 mm in diameter. Hakko Corporation also offers a wide range of other SMD rework units in a variety of sizes and capacities.

### SUMMARY OF THE INVENTION

This invention provides a method for creating features in an orthodontic aligner. A hot air source having a maximum flow rate of approximately 10 liters per minute is used to selectively heat a small region of the aligner above the thermoforming temperature of the aligner material. The heated region of the aligner is manipulated to form the desired feature, and then allowed to cool to solidify the feature. These features can be used, for example, to directly impart therapeutic forces on teeth, or for preparing aligners for attachment of aligner auxiliaries.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a perspective view of a region of an aligner 20 being heated with the hot air source 30.

FIG. 2 is a cross-sectional view of the aligner 20 showing manipulation of the heated region with a tool 42 to form a feature 22.

FIG. 3 is a detail perspective view of a portion of the aligner 20 showing manipulation the heated region with tweezers 40 to further form a feature 22.

FIG. 4 is a perspective view of the aligner 20 showing the finished feature 22.

FIG. 5 is a perspective view of an aligner 20 in which a divot 24 has been formed using the present method.

FIG. 6 is a detail cross-sectional view of a portion of the aligner 20 and the divot 24 corresponding to FIG. 5.

FIG. 7 is a detail perspective view of a portion of an aligner 20 with two divots 24 that exert a couple on a tooth 10.

FIG. 7(a) is a horizontal cross-sectional view of an aligner 20 with two divots 24 that exert a couple on a tooth 10, corresponding to FIG. 7.

FIG. 8 is a perspective view of an aligner 20 in which a raised land 23 has been formed to receive an aligner auxiliary.

FIG. 9 is a perspective view of an aligner corresponding to FIG. 8 after an aligner auxiliary 52 has been installed.

FIG. 10 is a cross-sectional view corresponding to FIG. 9 showing the aligner auxiliary 52 extending through the aligner 20.

### DETAILED DESCRIPTION OF THE INVENTION

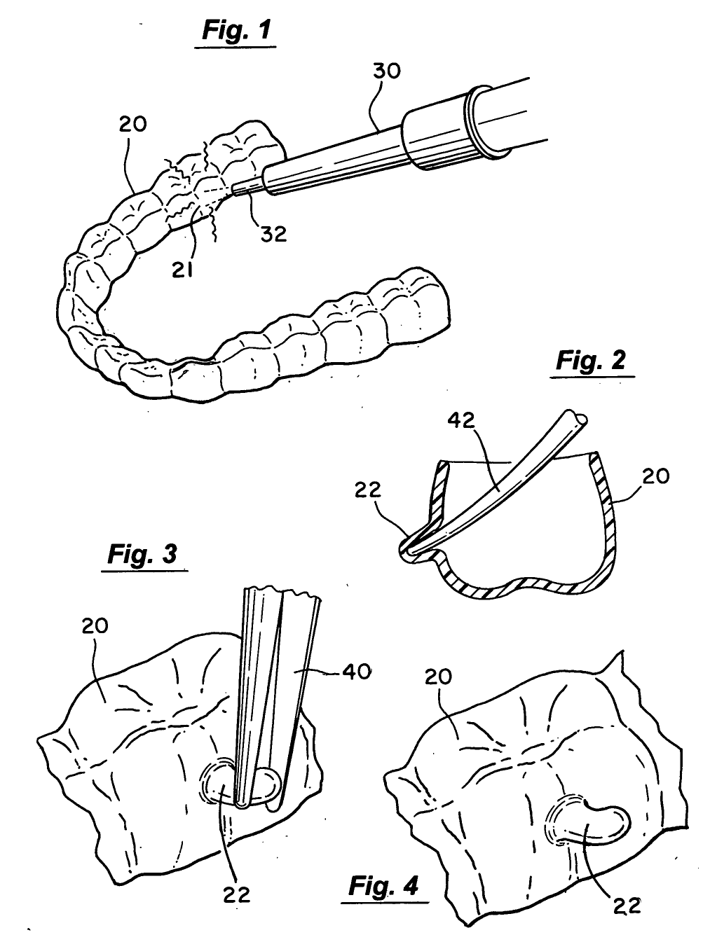

FIGS. 1 through 4 are perspective views illustrating the present methodology serving to form desired features in a conventional orthodontic aligner 20 made of a thin layer of thermoplastic material. FIG. 1 shows a small region 21 of the aligner 20 being heated by a very small stream of superheated air from a hot air source 30. The hot air source 30 preferably has a maximum flow rate of approximately 6 liters per minute and delivers air at a temperature in the range of approximately 400° to 500° F. For example, the Hakko 851 “SMD rework” unit marketed by Hakko Corporation of Osaka, Japan, has been found to be satisfactory for this purpose. It provides a convenient hand unit that enables a clinician to direct a small, precisely-controlled stream of heated air at a selected area 21 of the aligner 20. This unit allows adjustments over a wide ranges of temperatures and flow rates. In addition, a set of interchangeable nozzles 32 ranging from 1 to 3 mm in diameter are available.

Other hot air sources could be substituted in place of the Hakko unit. For example, a flow rate of up to approximately 10 liters per minute could be used. Also, air temperatures in the range of approximately 200° to 600° F. can be used, although lower temperatures will take longer to adequately heat the selected area 21 of the aligner 20. A range of orifice sizes from approximately 0.6 to 10 mm can be used. In addition, a wide variety of orifice shapes can be employed. The Hakko unit includes a set of round orifices. However, oval, square or rectangular orifices would also be suitable and are readily available in the marketplace.

As shown in FIG. 1, the clinician initially uses the hot air source 30 to selectively heat a small local region 21 of the aligner 20 above the thermoforming temperature of the thermoplastic material. The size of the heated region 21 can be controlled by the clinician by moving the nozzle 32 over a smaller or larger area of the aligner 20, as needed. The size of the heated region 21 and the rate of heating can also be changed by adjusting the air temperature or flow rate of the hot air source 30. The size of the heated region 21 and the rate of heating can also be changed by substituted a nozzle 32 of a different size.

Other than the small stream of superheated air, there is normally no physical contact between the nozzle 32 of the hot air source 30 and the aligner 20. Virtually all of the heat transfer from the hot air source 30 to the heated region 21 of the aligner 20 is accomplished by this stream of superheated air, rather than by contact between these components. This reduces the risk of inadvertent deformation of the aligner 20 or thinning of the wall of the aligner 20, such as could result from the use of other known aligner heating methods that involve physical contact between an aligner and a heat source.

After the selected local region 21 has been heated to a temperature above the thermoforming temperature of the thermoplastic material in the aligner 20, the clinician manipulates the heated region 21 of the aligner 20 with tools 40, 42 to form a desired feature 22, as shown in FIGS. 2 and 3. For example, FIG. 2 is a cross-sectional view of aligner 20 showing extrusion of a feature 22 by means of a pointed implement 42 acting from the inside of the aligner 20. FIG. 3 illustrates another example of other instruments 40, such as pliers or tweezers, being used to further form the small protrusion or hook 22 suitable for attaching an elastic band. The heated region 21 is then allowed to cool below the thermoforming temperature of the thermoplastic material in the aligner 20, which solidifies the feature 22. FIG. 4 is a perspective view of the aligner 20 showing a finished feature 22.

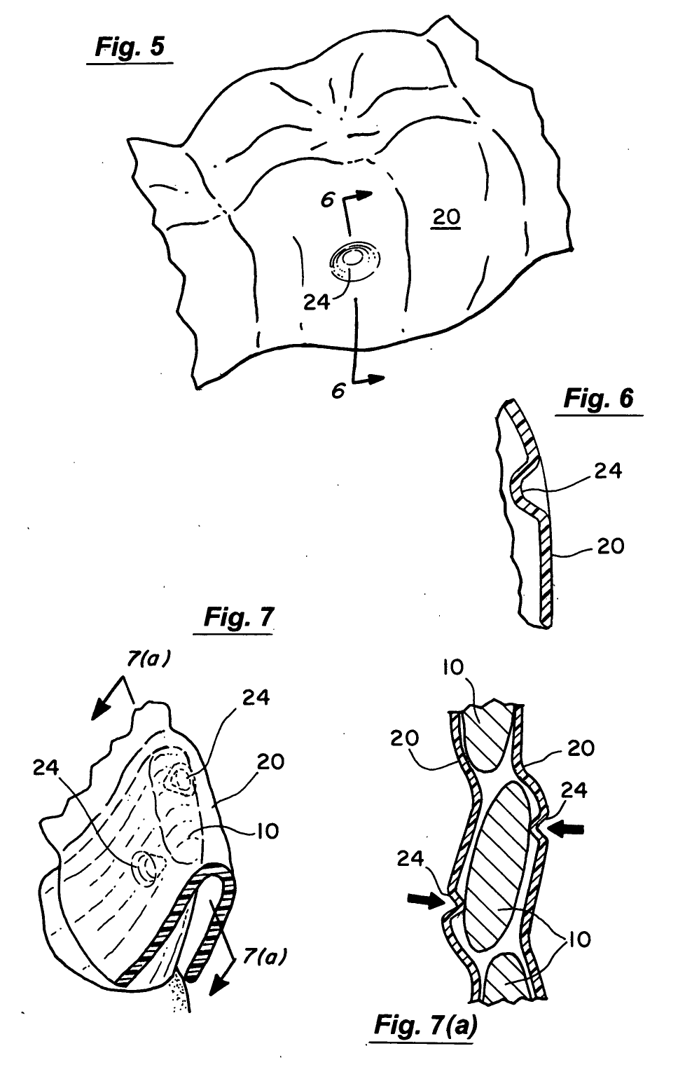

The feature 22 shown in FIGS. 3 and 4 is a small protrusion or hook. However, it should be understood that a wide range of features can be created using the present methodology. For example, this methodology can be employed to create a raised land, hook, eyelet, bubble, recess, post, window, retentive dimple or attachment point for an aligner auxiliary. FIG. 5 is a perspective view of an aligner 20 in which a divot 24 has been formed using the present method. FIG. 6 is a detail cross-sectional view of the divot 24 corresponding to FIG. 5.

Multiple divots 24 can be used to exert a couple to rotate a tooth 10. For example, FIG. 7 is a detail perspective view of a portion of an aligner 20 with two divots 24 that exert a couple on a tooth 10. FIG. 7(a) is a horizontal cross-sectional view corresponding to FIG. 7. In addition, the size, shape and depth of divots can be changed to progressively move or rotate a tooth over the course of treatment.

Optionally, holes or windows could be formed in the heated region 21 of the aligner 20 by means of a punch or die. For example, the beaks of a set of pliers could be formed to incorporate a punch or die for this purpose. If desired, an entire portion of the aligner adjacent to one side of a tooth could be removed to allow lateral movement of the tooth.

A wide variety of tools can be used to create features by deforming, molding, or cutting the thermoplastic material in the heated region 21 of the aligner 20. For example, pliers, forceps, tongs or tweezers can be used to deform, compress, pull, twist, flatten, mold, or depress the heated region 21 of the aligner 21. A simple elongated member can also be used to perform many of the same functions.

If needed, a selected local region 21 can be reheated a number of times to allow the clinician to progressively form a feature 22 in a series of stages, or to change the size, shape, location or orientation of a feature for the period of time that a particular aligner is used. An existing feature 22 can also be reheated so that it can be modified or removed. For example, this can be advantageous in progressively moving teeth toward desired positions over a series of stages of orthodontic treatment. Multiple features can be formed in a single aligner, and multiple aligners with similar features can be used to progressively move teeth over the course of treatment. For example, a first aligner can be initially formed in a conventional manner to move teeth toward desired positions during a first stage of treatment. After the first stage has been completed, the present methodology can be used to form a number of features 22 in the aligner that activate the aligner to move teeth further during a second stage of treatment. If necessary, these features can be amplified or shifted during a third stage of treatment to further “chase” the teeth. A second aligner can be used to continue treatment beyond the point where the first aligner and its features leave off.

In conventional thermoforming technology, there are well known limits to the maximum depth to which a concave pocket can be formed, given the surface area of the pocket and the thickness and physical properties of the thermoforming material. As the thermoforming material is sucked down into the pocket, it will stretch and thin out. Beyond certain limits, the thermoforming material either ruptures or delaminates into a paper-thin film. Surprisingly, experimental studies using the present methodology have produced features that are amazingly rigid and stout, even when exhibiting a significantly deeper draw than would be obtained by other conventional thermoforming techniques. In fact, these features appear to be almost as thick as the aligner material itself. This might be due to the significantly hotter temperatures provided by the Hakko unit. It might also result from the more-gradual temperature gradients in the aligner material caused by convection heating in the present methodology, in contrast to the more abrupt temperature gradients produced by conventional heating methods involving physical contact between an aligner and a heat source.

A feature 22 can be designed to directly exert a therapeutic force on one or more teeth by itself. For example, the divot 24 shown in FIGS. 5 and 6 can be used to contact and exert a force on a tooth. Features can also be combined to exert a couple for rotation of a tooth. An outset void or window can be formed to created space for a tooth to move into.

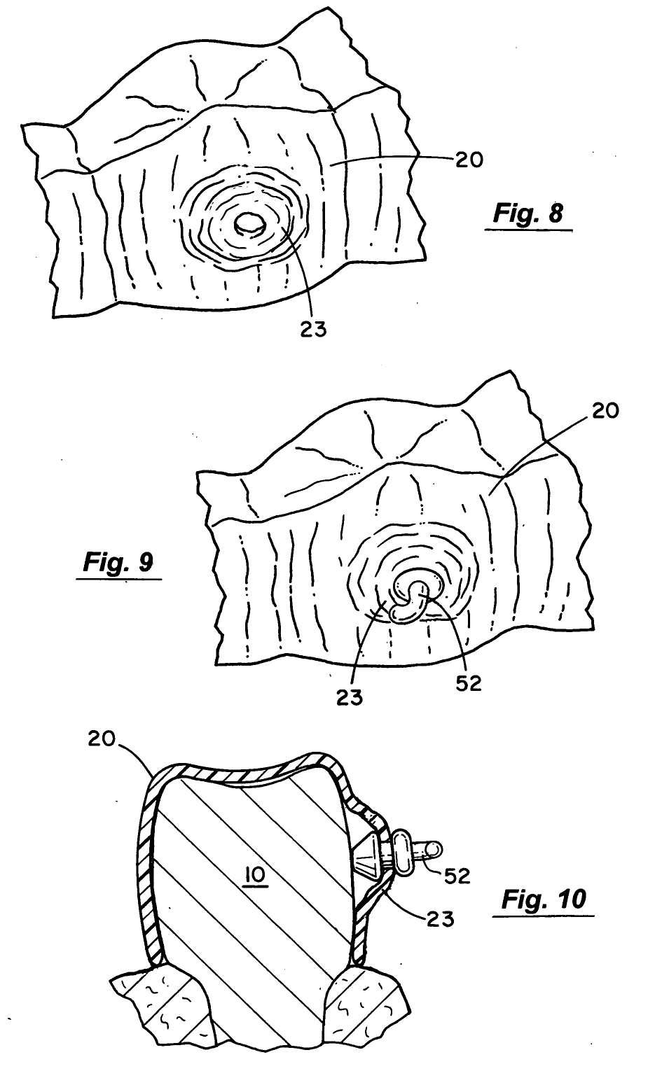

In addition, the features 22 created in an aligner 20 using the present methodology can be designed for use in conjunction with aligner auxiliaries, as illustrated in FIGS. 8 through 10. A wide variety of such aligner auxiliaries are disclosed in the Applicant's U.S. Pat. No. 6,702,575, entitled “Orthodontic Aligner Auxiliary System,” issued on Mar. 9, 2004, which is incorporated herein by reference. The term “aligner auxiliary” should be broadly construed to include all types of devices (such as tacks, screws, hooks, elastics, anchors and expansion mechanisms) that can be used in conjunction with an aligner 20 to exert a therapeutic force on one or more teeth. For example, FIG. 8 is a perspective view of an aligner 20 in which a raised land 23 has been formed using the present methodology to receive an aligner auxiliary (i.e., a hook 52). As previously discussed, the raised land 23 is created by heating a localized region of the aligner with a small stream of superheated air, and then deforming the shell of the aligner outward with a tool. A small hole is then formed in the raised land 23 to accept the aligner auxiliary. FIG. 9 is a perspective view of an aligner corresponding to FIG. 8 after the aligner auxiliary 52 has been installed in the raised land 23. FIG. 10 is a cross-sectional view corresponding to FIG. 8 showing the base of the aligner auxiliary 52 inserted through the hole in the aligner 20. The raised land 23 prevents the base of the aligner auxiliary 52 from undesirably contacting the tooth 10. The head of the aligner auxiliary 52 remains outside the aligner 20. In the example shown in FIG. 10, the hook portion of the aligner auxiliary 52 can be employed to engage an elastic to exert a therapeutic force on the tooth 10.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A method for creating features in an orthodontic aligner made of a thin layer of thermoplastic material comprising:
selectively heating a small region of the aligner above the thermoforming temperature of the thermoplastic material with a hot air source having a maximum flow rate of approximately 10 liters per minute;
manipulating the heated region of the aligner to form a feature; and
cooling the heated region below the thermoforming temperature of the thermoplastic material to solidify the feature.

2. The method of claim 1 wherein the hot air source supplies air at a temperature of approximately 200° to 600° F.

3. The method of claim 1 wherein the hot air source supplies air through a nozzle having a diameter of approximately 0.6 to 10 mm.

4. The method of claim 1 wherein the feature comprises a raised land for installation of an aligner auxiliary.

5. The method of claim 1 wherein the feature comprises an attachment point for an aligner auxiliary.

6. The method of claim 1 wherein the feature comprises a hook.

7. The method of claim 1 wherein the feature comprises a bump.

8. A method for modifying an orthodontic aligner made of a thin layer of thermoplastic material, said method comprising:
selectively heating a small region of the aligner above the thermoforming temperature of the thermoplastic material with a hot air source having a maximum flow rate of approximately 10 liters per minute;
manipulating the heated region of the aligner to form a feature;
cooling the heated region below the thermoforming temperature of the thermoplastic material to solidify the feature; and
attaching an aligner auxiliary to the feature.

9. The method of claim 8 wherein the hot air source supplies air at a temperature of approximately 200° to 600° F.

10. The method of claim 8 wherein the hot air source supplies air through a nozzle having a diameter of approximately 0.6 to 10 mm.

11. The method of claim 8 wherein the feature comprises a raised land for installation of an aligner auxiliary.

12. The method of claim 8 wherein the feature comprises an attachment point for an aligner auxiliary.

13. The method of claim 8 wherein the feature comprises a hook.

14. The method of claim 8 wherein the feature comprises a bump.

15. A method for modifying an orthodontic aligner made of a thin layer of thermoplastic material over a sequence of stages of orthodontic treatment to progressively move teeth toward desired positions, wherein at least one stage of orthodontic treatment comprises:
selectively heating a small region of the aligner above the thermoforming temperature of the thermoplastic material with a hot air source having a maximum flow rate of approximately 10 liters per minute;
manipulating the heated region of the aligner to form a feature;
cooling the heated region below the thermoforming temperature of the thermoplastic material to solidify the feature; and
using the feature to exert a therapeutic force on at least one tooth during the stage of treatment.

16. The method of claim 15 wherein a progressive series of aligners are used in sequence over the stages of treatment.

17. The method of claim 15 further comprising attaching an aligner auxiliary to the feature to exert a therapeutic force on at least one tooth.

18. The method of claim 15 wherein the hot air source supplies air at a temperature of approximately 200° to 600° F.

19. The method of claim 15 wherein the hot air source supplies air through a nozzle having a diameter of approximately 0.6 to 10 mm.
